(19) United States
(12) Patent Application Publication
(10) Pub. No.: US 2024/0161782 A1
(43) Pub. Date: May 16, 2024

(54) Apparatuses, Systems, and Methods for Creating and Accessing Video Clips of a Game Played on a Playing Field

(71) Applicant: Soccer Park, LLC dba Urban Soccer Park, Boise, ID (US)

(72) Inventors: Joshua Leland Frazier, Boise, ID (US); Justin Shook, Boise, ID (US)

(73) Assignee: Soccer Park, LLC dba Urban Soccer Park, Boise, ID (US)

(21) Appl. No.: 18/055,749

(22) Filed: Nov. 15, 2022

(51) Int. Cl. G11B 27/031; G06V 10/94; G06V 20/40; G06V 40/20; H04N 5/232; H04N 5/247; H04N 5/77

(52) U.S. Cl. CPC G11B 27/031; G06V 10/95; G06V 20/42; G06V 20/49; G06V 40/23; H04N 5/23299; H04N 5/247; H04N 5/77

(57) ABSTRACT

Apparatuses, systems, and methods for creating video clips of a game played on a playing field enclosed by walls, door(s), and two goals. The system includes a plurality of cameras positioned around the playing field. The system includes one or more QR codes. The system includes a computer-based controller in communication with the cameras. The controller comprises a set of computer-based instructions to cause at least one processor to carry out functions associated with one or more modules. The system includes a ball detection module that controls the cameras to track a ball on the playing field to create video of a game. The system includes an event detection module configured to detect specified events that occur during games. The system includes a highlight module that creates video clips from the video of games played. The video clips correspond to specified events detected by the event detection module.

### FIELD OF THE DISCLOSURE

The embodiments described herein relate to apparatuses, systems, and methods for creating and accessing video clips of a game occurring on a playing field.

### BACKGROUND

### Description of the Related Art

As used herein the terms “game” or “games” refers to an observable physical activity, such as soccer, football, field hockey, ice hockey, handball, or the like, and includes matches against two teams, practice sessions, demonstrations, and the like. Games may be played on a field enclosed by walls. Participants may want to view specific events of the game after the game is done or after the event occurred. Such events may be recorded by spectators. However, the spectator may miss the event or the recording angle may not be optimal providing a less the desired video. Other disadvantages may exist.

### SUMMARY

The present disclosure is directed to apparatuses, systems, and methods for creating video clips of a game played on a playing field.

One embodiment of the disclosure is a system. The system includes a playing field enclosed by walls, one or more doors, and two goals. The system includes a plurality of cameras positioned around the playing field. The system includes one or more quick response (QR) codes located on the walls or the one or more doors of the playing field. The system includes a computer-based controller in communication with the plurality of cameras. The controller comprises a set of computer-based instructions to cause at least one processor to carry out functions associated with one or more modules.

The system includes a ball detection module. The ball detection module controls the plurality of cameras to track a ball on the playing field a create video of a game played, on the field. The system includes an event detection module. The event detection module is configured to detect specified events that occur during games played on the playing field. The system includes a highlight module. The highlight module creates video clips from the video of games played on the playing field. The video clips correspond to specified events detected by the event detection module.

The specified events may include a shot on goal, a score, or a skill move. The at least one QR code may be located on an interior of the wall or the more or more doors of the playing field. The at least one QR code may be located on an exterior of the walls or the one or more doors of the playing field. The plurality of cameras may include at least one camera positioned above each goal. The plurality of cameras include at least one camera positioned at each corner of the playing field. The plurality of cameras may include at least two cameras positioned at a centerline of the playing field.

The highlight module may create video clips stored in a cloud network in communication with the controller. When one of the one or more QR codes are scanned by a mobile device the controller may send an inquiry to the mobile device to select a detected specified event. Upon selection of the detected specified event the controller may send a video clip that corresponds to the selected detected specified event. The highlight module may create video clips from multiple angles for each event detected by the event detection module. Upon selection of the detected specified event the controller may send an inquiry to the mobile device whether multiple angle views of the selected detected specified event are requested. Upon receipt that multiple angle views of the selected detected specified event are requested the controller may send a video clip that corresponds to the selected detected specified event and the video clip includes more than one viewing angle.

One embodiment of the present disclosure is a method. The method includes recording a game played on a playing field to create a video, the playing field enclosed by walls, one or more doors, and two goals. The game is recorded by a plurality of cameras positioned about the playing field. The method includes tracking a ball while recording the game. A computer-based controller comprises a set of computer-based instructions to cause at least one processor to carry out functions associated with one or more modules. The modules comprises a ball detection module, an event detection module, and a highlight module. The ball detection module controls the plurality of cameras to track the ball on the playing field. The event detection module detects specified events that occur during a game. The highlight module creates video clips from the video. The video clips correspond to specified events detected.

The specified events may include a shot on goal, a score, or a skill event. The method may include creating video clips that include more than one viewing angle for each detected specified event. The method may include receiving a QR code from a mobile device. The method may include sending the video clips to the mobile device. The method may include sending a request to the mobile device to select a detected specified event. The method may include receiving the selection of the detected specified event from the mobile device. The method may include sending a video clip of the selected detected specified event to the mobile device, wherein the video clip includes more than one viewing angle of the selected detected specified event.

### BRIEF DESCRIPTION OF THE DRAWINGS

FIG. 1 is a schematic of an embodiment of a system that may be used to create video clips from video of a game.

FIG. 2 shows an embodiment of a playing field.

FIG. 3 shows an embodiment of a playing field.

FIG. 4 shows an embodiment of a camera position in the corner of a playing field.

FIG. 5 shows an embodiment of a camera positioned over a goal of a playing field.

FIG. 6 shows a representative QR code.

FIG. 7 is a flow chart of one embodiment of a method for creating video clips.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the invention as defined by the appended claims.

### DETAILED DESCRIPTION

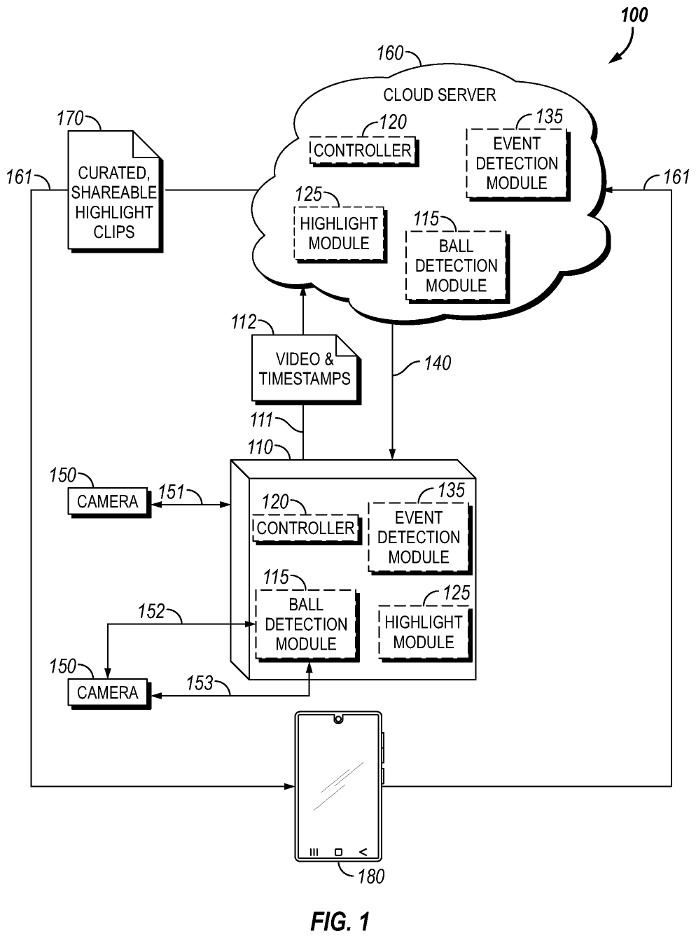

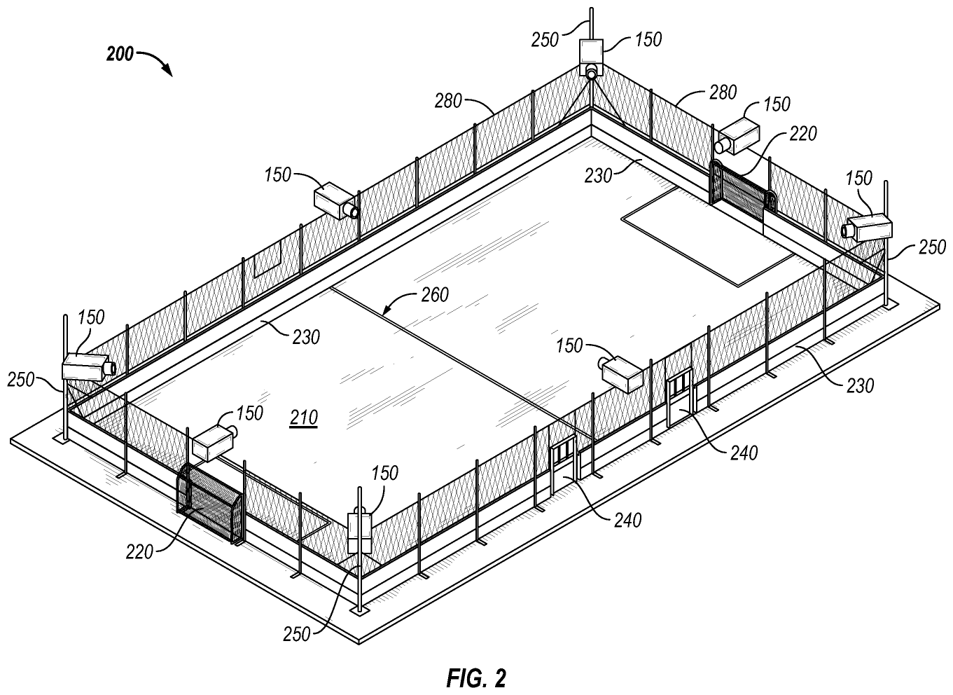

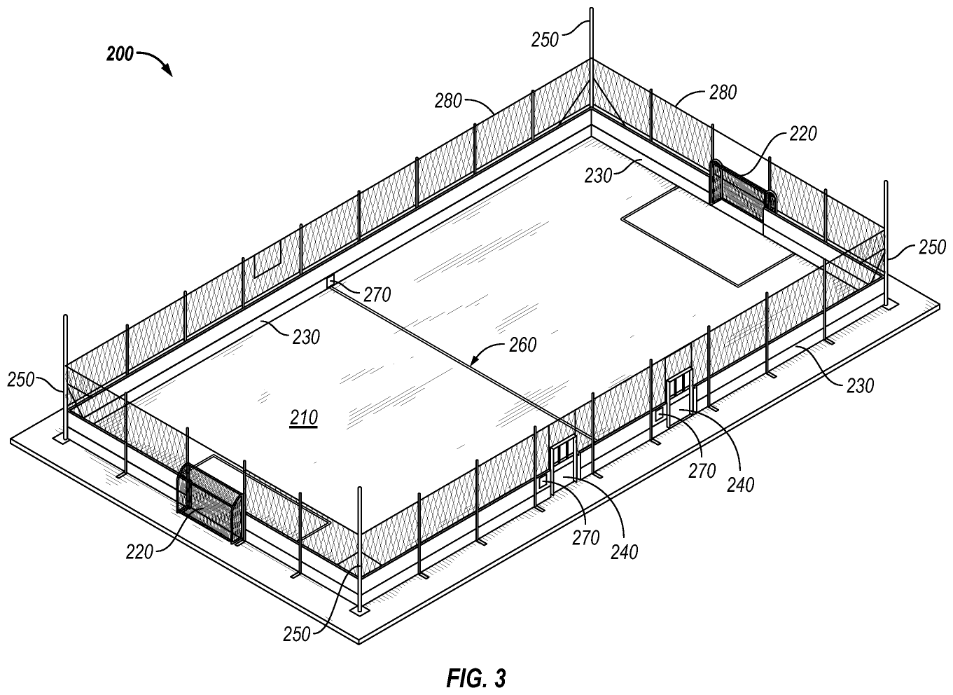

FIG. 1 shows a system 100 that may be used to create video clips from video of a game played on a playing field 200 (shown in FIGS. 2 and 3). As defined above, the game may be, but is not limited to, a soccer game played on a soccer field. However, the system 100 may be used to video and create video clips of various games on various fields as would be appreciated by one of ordinary skill in the art having the benefit of this disclosure. The system 100 includes a computer 110. The field 200 includes a plurality of cameras 150 positioned about the field 200 as discussed herein. The computer 110 may be positioned local to the playing field 200 or may be located elsewhere and be in communication with the plurality of cameras 150. For example, the computer 110 may communicate with the cameras 150 via a wired or a wireless network.

The system 100 includes a controller 120. The controller 120 may be a hardware device of a software program that manages or directs the flow of data between the various elements of the system 100. The controller 120 may be a card, microchip, or separate hardware device as would be appreciated by one of ordinary skill in the art having the benefit of this disclosure. The controller 120 may be comprised of one or more processors located within the computer 110 and/or the controller 120 may control the operation of one or more processors that the controller 120 is in communication with. Likewise, the controller 120 may be located on a cloud server 160, or the like, and may communicate wirelessly with the computer 110 via a communication line 140. The controller 120, which may be a computer-based controller, is in communication with each of the plurality of cameras 150 positioned about the playing field. The controller comprises a set of computer-based instructions to cause at least one processor to carry out functions associated with one or more modules. The system 100 may include various modules that are programmed to perform various tasks or functions within the system.

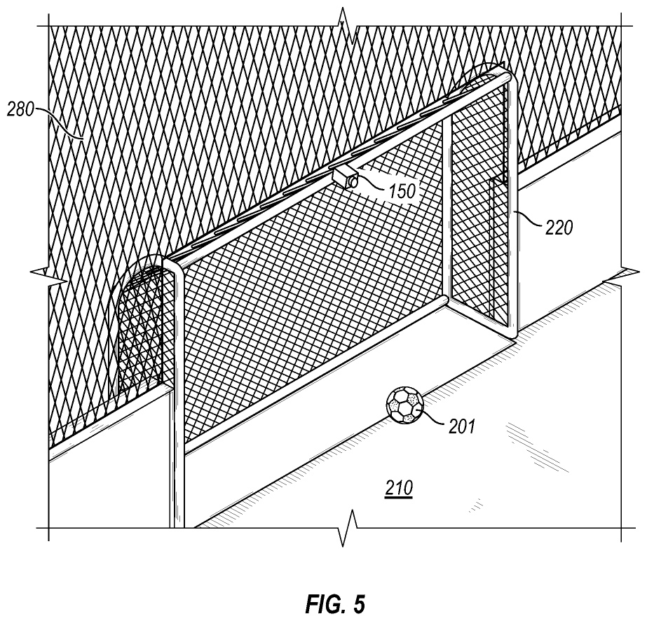

The system 100 includes a ball detection module 115. The ball detection module 115 may be located on the computer 110 and/or may be located on a cloud server 160. The controller 120 controls the ball detection module 115. The ball detection module 115 controls the plurality of cameras 150 to track a ball 201 (shown in FIG. 5) on the playing field to create video of a game played on the field 200. As discussed herein, the ball 201 may be, but is not limited to, a soccer ball and could be a puck, handball, basketball, or the like. The ball detection module 115 may control each camera 150 of the plurality of cameras 150 via a communication lines 151, 152, and 153. Communication lines 151, 152, 153 may be wired or wireless as would be appreciated by one of ordinary skill in the art having the benefit of this disclosure.

Video captured by the one or more cameras 150 may be transmitted to the computer 110 and/or controller 120 via communication lines 151, 152, 153. The number of cameras 150 shown in FIG. 1 is for illustrative purposes and may be varied as would be appreciated by one of ordinary skill in the art having the benefit of this disclosure. The computer 110 and/or controller 120 prepares video 112 from captured video received from the one or more cameras 150. The video 112 include time stamps as it is created by the computer 110 and/or controller 120. The computer 110 and/or controller 120 may wirelessly transmit the video 112 to the cloud server 160 via a communication line 111. Alternatively, the computer 110 and/or controller 120 may wirelessly transmit the video 112 to the cloud server 160 via a communication line 140. There may be one or more communication lines between the computer 110/controller 120 and the cloud server 160. The time stamps on the video 112 may be used by the highlight module 125 during the creation of video clips 170 as discussed herein.

The system 100 includes an event detection module 135. The event detection module 135 may be located on the computer 110 and/or may be located on a cloud server 160. The event detection module 135 is configured to detect specified events that occur during games played on the playing field 200. For example, if the game is a soccer game the event detection module 135 may be programmed to detect a shot on goal, a score, or a skill move. For a soccer game, a skill move comprises, but is not limited to, a Roulette, a Cruyff Turn, an Elastico (also known as a flip flap), a Hocus Pocus, a Nutmeg, an Okocha, a Rabona, a Rivelino, a Fake Pull Back, a Cut, a Matthews Cut, a Rainbow, a Ronaldo Chop, an Inside Hook, a Pull Back V, a Step Over, a Single Lunge, or a Double Lunge. For example, if the game is a football game the event detection module 135 may be programmed to detect a turnover (e.g., an interception or a fumble), a score, or a skill move. A skill move may be, but is not limited to, a Pancake Block, a Pass Deflection, a Sack, a Tackle for Loss, a One Handed Reception, or a Chunk Play. As those of ordinary skill in the art having the benefit of this disclosure would understand other skill moves may be defined for other games as is appropriate.

The system 100 includes a highlight module 125. The highlight module 125 may be located on the computer 110 and/or may be located on a cloud server 160. The highlight module 125 creates video clips 170 from the video 112 of games played on the playing field 200. The video clips 170 correspond to specified events detected by the event detection module 135. The highlight module 125 may create video clips that are stored in a cloud network and/or a cloud server 160 in communication with the controller 120. The highlight module 125 may create video clips 170 from multiple angles for each event detected by the event detection module 135. The multiple angles of the video clip 170 may be created from the various cameras 150 positioned about the field 200. Upon selection of the detected specified event, the controller 120 may send an inquiry to the mobile device 180 whether multiple angle views of the selected detected specified event are requested. Upon receipt that multiple angle views of the selected detected specified event are requested, the controller 120 may send a video clip 170 that corresponds to the selected detected specified event and the video clip 170 includes more than one viewing angle. Under control of the controller 120, video clips 170 having more than one viewing angle may be automatically generated by the highlight module 125 upon detection of an event by the event detection module 135.

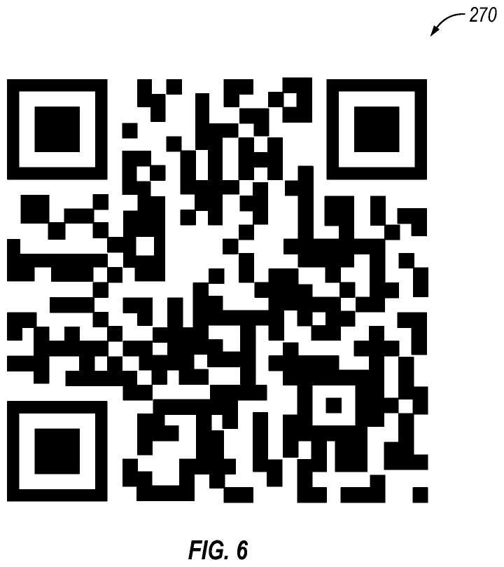

The system 100 includes one or more quick response (QR) codes 270 (shown in FIGS. 3 and 6) located about the playing field 200. A QR code 270 may be scanned to access video and/or video clips from a game played on the field 200 as discussed herein. A user may use a mobile device 180 to scan a QR code 270 that is positioned about the playing field 200. The scanned QR code 270 may be wirelessly communicated to the cloud server 160 via communication line 161. Upon receipt of the QR code 270, the controller 120 controls the highlight module 125 to create one or more video clips 170, which may be wirelessly communicated to the mobile device 180 via a communication line 161.

A QR code 270 may be received by the system 100 upon being scanned by a mobile device 180. Upon receipt of the QR code 270, the system 100 may send a video 112 of a played game to the mobile device 180. The video 112 sent may be determined by the time that the QR code 270 is scanned. For example, if the QR code 270 is scanned within a predetermined time after the completion of a particular game, the video for that particular game may be sent to the mobile device 180. When a QR code 270 is scanned by a mobile device 180 the controller 120 may send an inquiry to the mobile device 180 to select a detected specified event. A list of detected specified events may be sent to the mobile device 180 based on the time the QR code 270 is scanned by the mobile device 180. Upon selection of a detected specified event, the controller 120 sends a video clip 170 to the mobile device 180. The video clip 170 corresponds to the selected detected specified event.

FIG. 2 shows an embodiment of a field 200 that includes a playing surface 210. The playing surface 210 may be grass, turf, ice, or the like, as would be appreciated by one of ordinary skill in the art having the benefit of this disclosure. The field 200 includes one or more doors 240 connected to a plurality of walls 230. The field 200 include two goals 220 with one goal 220 being positioned at each end of the field 200. The field 200 may include a net 280 positioned around the field 200 to potentially keep the ball 201 within the perimeter of the field 200. The field 200 includes a plurality of cameras 150 positioned about the field 200. For example, a camera 150 may be positioned above each goal 220. A camera 150 may be positioned in each corner 250 of the field 200. Two cameras 150 may be positioned at midfield 260 with a camera 150 being positioned on each side of the field 200. More than one camera 150 may be positioned at a location about the field 200 as would be appreciated by one of ordinary skill in the art having the benefit of this disclosure. The number, location, and/or configurations of the cameras 150 are shown for illustrative purposes and may be varied as would be appreciated by one of ordinary skill in the art having the benefit of this disclosure. One or more of the cameras 150 may be controlled by the ball detection module 115 via the controller 120 to track the movement of a ball 201 and record the playing of a game on the field 200. Each of the cameras 150 about the field may track the ball 201 and record the game to provide multiple viewing angles of each event detected by the event detection module 135.

FIG. 3 shows an embodiment of a field 200 that includes a playing surface 210. One or more QR codes 270 may be positioned about the field 200. For example, a QR code 270 may be positioned on the interior (i.e., inside of the playing field) of a wall 230 or door 240 of the field 200. A QR code 270 may be positioned on the exterior (i.e., outside of the field) of a wall 230 or door 240 of the field 200. A QR code 270 may be scanned by a mobile device 180 to receive a video of a game played on the adjacent field 200 and/or video clips of highlights (e.g., detected events) of a game played on the adjacent field 200 as discussed herein. The number and/or location of the QR codes 270 are shown for illustrative purposes any may be varied as would be appreciated by one of ordinary skill in the art having the benefit of this disclosure. For example, a QR code 270 may be positioned on another structure positioned adjacent to the field 200.

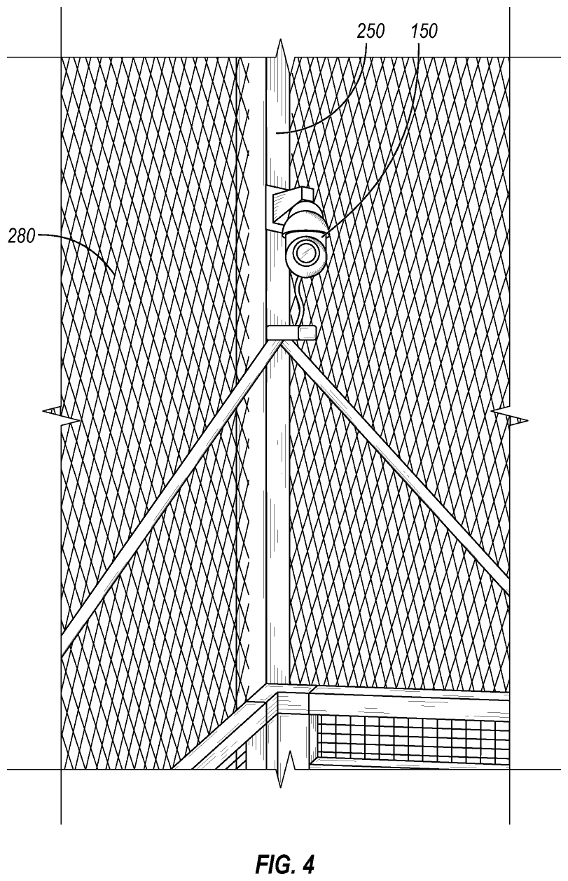

FIG. 4 shows a camera 150 positioned within a corner 250 of the playing field 200. The camera 150 may be positioned inside a net 280 of the playing field 200 so that the net is not in the video captured by the camera 150. Alternatively, a camera 150 may be positioned outside of a net 280 and software may be used to remove the net 280 from the capture video from the camera 150. FIG. 5 shows a camera 150 positioned above a goal 220 of the playing field 200. A ball 201 is positioned on the playing surface 210 adjacent to the goal 220. As discussed above, the ball 201 is not limited to a soccer ball and the goal 220 is not limited to a soccer goal. For example, the ball may be, but is not limited to, a basketball and the goal may be, but is not limited to, a basketball hoop. FIG. 6 shows a sample QR code 270.

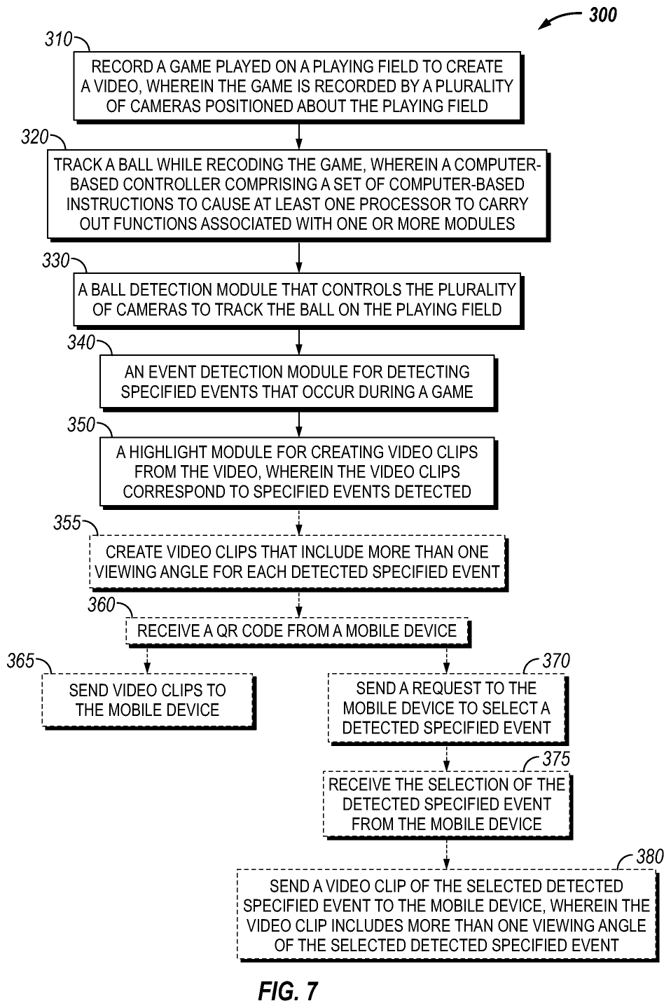

FIG. 7 is a flow chart of one embodiment of a method 300 of the present disclosure. The method 300 includes recording a game played on a playing field to create a video, wherein the game is recorded by a plurality of cameras positioned about the playing field, at 310. The playing field 200 may enclosed by walls 230, one or more doors 240, and two goals 220. The method 300 includes tracking a ball 201 while recording the game, wherein a computer-based controller 120 comprising a set of computer-based instructions to cause at least one processor to carry out functions associated with one or more modules, at 320. The method 300 includes a ball detection module 115 that controls the plurality of cameras to track the ball on the playing field, at 330. The method 300 includes an event detection module 135 for detecting specified events that occur during a game, at 340. The method 300 includes a highlight module 125 for creating video clips 170 from the video 112, wherein the video clips 170 correspond to specified events detected, at 350.

The method 300 may include creating video clips that include more than one viewing angle for each detected specified event, at 355. The method 300 may include receiving a QR code 270 from a mobile device 180, at 360. The method 300 may include sending video clips 170 to the mobile device 180, at 365. The method 300 may include sending a request to the mobile device 180 to select a detected specified event, at 370. The method 300 may include receiving the selection of the detected specified event from the mobile device 180, at 375. The method 300 may include sending a video clip 170 of the selected detected specified event to the mobile device 180, wherein the video clip 170 includes more than one viewing angle of the selected detected specified event, at 380.

Although this disclosure has been described in terms of certain preferred embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof.

What is claimed is:

1. A system comprising:
a playing field enclosed by walls, one or more doors, and two goals;
a plurality of cameras positioned around the playing field;
one or more quick response (QR) codes located on the walls or the one or more doors of the playing field;
a computer-based controller in communication with the plurality of cameras, the controller comprising a set of computer-based instructions to cause at least one processor to carry out functions associated with one or more modules comprising:
a ball detection module, wherein the ball detection module controls the plurality of cameras to track a ball on the playing field to create video of a game played on the field;
an event detection module, wherein the event detection module is configured to detect specified events that occur during games played on the playing field; and
a highlight module, wherein the highlight module creates video clips from the video of games played on the playing field, wherein the video clips correspond to specified events detected by the event detection module.

2. The system of claim 1, wherein the specified events comprises a shot on goal, a score, or a skill move.

3. The system of claim 2, wherein at least one QR code is located on an interior of the walls or the one or more doors of the playing field and wherein at least one QR code is located on an exterior of the walls or the one or more doors of the playing field.

4. The system of claim 2, wherein the plurality of cameras include at least one camera positioned above each goal.

5. The system of claim 2, wherein the plurality of cameras include at least one camera positioned at each corner of the playing field.

6. The system of claim 2, wherein the plurality of cameras include at least two cameras positioned at a centerline of the playing field.

7. The system of claim 2, wherein the highlight module creates video clips stored in a cloud network in communication with the controller.

8. The system of claim 2, wherein when one of the one or more QR codes are scanned by a mobile device the controller sends an inquiry to the mobile device to select a detected specified event.

9. The system of claim 8, wherein upon selection of the detected specified event the controller sends a video clip that corresponds to the selected detected specified event.

10. The system of claim 8, wherein the highlight module creates video clips from multiple angles for each event detected by the event detection module.

11. The system of claim 10, wherein upon selection of the detected specified event the controller sends an inquiry to the mobile device whether multiple angle views of the selected detected specified event are requested.

12. The system of claim 11, wherein upon receipt that multiple angle views of the selected detected specified event are requested the controller sends a video clip that corresponds to the selected detected specified event and the video clip includes more than one viewing angle.

13. A method comprising:
recording a game played on a playing field to create a video, the playing field enclosed by walls, one or more doors, and two goals, wherein the game is recorded by a plurality of cameras positioned about the playing field;
tracking a ball while recording the game, wherein a computer-based controller comprising a set of computer-based instructions to cause at least one processor to carry out functions associated with one or more modules comprising:
a ball detection module that controls the plurality of cameras to track the ball on the playing field;
an event detection module for detecting specified events that occur during a game; and
a highlight module for creating video clips from the video, wherein the video clips correspond to specified events detected.

14. The method of claim 13, wherein the specified events comprises a shot on goal, a score, or a skill event.

15. The method of claim 14, wherein creating video clips from the video further comprises creating video clips that include more than one viewing angle for each detected specified event.

16. The method of claim 15, further comprising receiving a quick response (QR) code from a mobile device.

17. The method of claim 16, further comprising sending the video clips to the mobile device.

18. The method of claim 16, further comprising sending a request to the mobile device to select a detected specified event.

19. The method of claim 18, further comprising receiving the selection of the detected specified event from the mobile device.

20. The method of claim 19, further comprising sending a video clip of the selected detected specified event to the mobile device, wherein the video clip includes more than one viewing angle of the selected detected specified event.
